(19) United States
(12) Patent Application Publication
(10) Pub. No.: US 2012/0122641 A1
(43) Pub. Date: May 17, 2012

(54) SLOTTER, A METHOD FOR CUTTING BY SLOTTER, SLOTTER KNIFE, AND SWIVEL

(75) Inventors: Kazuya Sugimoto, Hiroshima (JP); Osamu Hatano, Hiroshima (JP)

(73) Assignee: MITSUBISHI HEAVY INDUSTRIES PRINTING & PACKAGING MACHINERY, LTD., Mihara-shi, Hiroshima (JP)

(21) Appl. No.: 13/381,397

(22) PCT Filed: Jun. 21, 2010
(86) PCT No.: PCT/JP2010/060469

§ 371 Date: Dec. 29, 2011

(30) Foreign Application Priority Data
Jul. 8, 2009 (JP) 2009-161665

(51) Int. Cl. B31B 1/22; B26D 1/22

(52) U.S. Cl. 493/60

(57) ABSTRACT

An upper slotter knife is divided into a slotter knife body and a division, and the position of the division relative to a sliding member in which a flap cutter knife is embedded is determined and fixed such that a distance between a nick formed on a cutting blade of the division and the tip of a flap cutter knife is minimized. The presence of the nick makes it possible to form a connection between the slotted chip and the flap chip even when the sizes and the shapes of the corrugated sheet and the joint margin vary. The presence of the connecting point makes it possible to remove the flap chip together with the slotted chip, so that scattering of the flap chip and inferior gluing of the joint margin can be prevented.

### CROSS-REFERENCE TO RELATED APPLICATION

This application is a National Stage of PCT international application Ser. No. PCT/JP2010/060469 filed on Jun. 21, 2010 which is based upon and claims the benefit of priority from Japanese Patent Application No. 2009-161665 filed on Jul. 8, 2009.

### TECHNICAL FIELD

The present invention relates to a slotter that cuts off a one side corner portion of a rectangular corrugated sheet to form a joint margin of one side of the corrugated sheet.

### Background

As illustrated in FIG. 11, a corrugated sheet 1 fabricated by a corrugator has a number of ruled lines 2a and 2b in the longitudinal direction. The corrugated sheet 1 is formed into a cardboard box by a case former. In the case former, a printer firstly prints appropriately; a creaser forms ruled lines 3a-3d in the width direction; and a slotter forms slots 4. The series of the above processes forms flaps 6 that are to serve as the cover face and the bottom face.

A flap cutter knife mounted on the slotter cuts off corner potions at one of the ends of the longitudinal direction to form a joint margin 5 on the one side. In succession, the joint margin 5 is pasted and the corrugated sheet is bent at the ruled lines 3a-3d, so that the joint margin 5 is glued to the other side of the sheet. Consequently, the corrugated sheet 1 is formed into a tube to serve as a cardboard box.

The slots 4 and the joint margin 5 are formed by a slotter included in a case former. The slotter includes a number of swivels arranged in the longitudinal direction of the corrugated sheet 1 each of which swivels has a slotter knife, so that a number of slots 4 are formed on the corrugated sheet 1. An example of a part of the slotter which part forms the joint margin 5 will now be described with reference to FIGS. 12 and 13.

A slotter 100 shown in FIGS. 12 and 13 includes: rotation axes 102 and 104 arranged in parallel in the vertical direction; a circular upper swivel 106 and a circular lower swivel 108 disposed around rotation axes 102 and 104, respectively; a pair of upper slotter knives 110 which have certain widths, which are disposed on the edge of the upper swivel 106, and which have a predetermined distance along the circumference direction of the upper swivel 106; and flap cutter knives 112 one across each upper slotter knife 110. The lower swivel 108 includes a recess 114 into which the lower outer portion of the upper slotter knives 110 can be fitted. The both outer side edges of each upper slotter knife 110 are regarded as the cutting blades 111, and the both side edges of the recess 114 are regarded as receiving blades 116. A portion of outer-circumference of the lower swivel 108 which portion corresponds to the flap cutter knives 112 is regarded as a blade receiving face 118.

Furthermore, a scraper 120 is disposed inside the recess 114 and removes slotted chips clogging the recess 114. One upper slotter knife 110 positioning at the front end in the rotating direction includes a cutting blade 122 positioning at the rear end in the rotating direction and projecting exterior. The cutting blade 122 cuts the bottom (in FIG. 11, points in the vicinity of the intersections of the slots 4 and the ruled line 2a or 2b) of each slot 4. The other upper slotter knife 110 includes an identical cutting blade 122 at the front end in the rotating direction.

The slotter 100 is placed according to the position where the joint margin 5 is to be formed. A corrugated sheet 1 is feed into a space between the upper and lower swivels 106 or 108 in the direction that the arrows in FIGS. 11 and 12 indicate. At that time, the upper and lower swivels 106 and 108 rotate in the directions that the respective arrows in FIG. 12 indicate, and slots 4 are formed on one end of the corrugated sheet 1 by fitting the upper slotter knives 110 into the corresponding recesses 114. The effect caused by contact between the flap cutter knife 112 and the blade receiving face 118 cuts off a portion from the bottom of the slot 4 to the end of the corrugated sheet 1 in the longitudinal direction, so that a joint margin 5 is formed on the one end of the corrugated sheet 1 as illustrated in FIG. 11.

A creaser, which is disposed at the same position of the slotter 100 as the width-direction position of the corrugated sheet 1 and which does not appear in the drawings, forms the ruled line 3d. Additional non-illustrated swivels are arranged around the rotation axes 102 and 104 in parallel with the slotter 100 in the direction perpendicular to the direction that the corrugated sheet 1 travels. These additional swivels form slots 4 and creasers mounted on other axis form the ruled lines 3a-3c.

As illustrated in FIG. 15 or 16, the upper slotter knife 110 cut-removes a slotted chip 7 and concurrently forms a slot 4, and the flap cutter knife 112 forms a detaching line c and cut-removes a flap chip 8. Thereby, the joint margin 5 is formed.

FIG. 15 illustrates the bottom of the slot 4 that agrees with the detaching line c while FIG. 16 illustrates the bottom of the slot 4 that disagrees with the detaching line c.

As illustrated in FIGS. 15 and 16, the presence of a discontiguous portion between the slot 4 and the detaching line C may not remove the flap chip 8, which causes inconvenience such as: inferior gluing of the joint margin 5 if the flap chip 8 is pasted in the pasting step and is glued to the corrugated sheet 1; and inaccuracy bending at a ruled line and intrusion of the flap chip into the fabricated corrugated sheet if the flap chip 8 remains across the ruled lines 2a and 2b or across the ruled lines 3a through 3d.

As a solution, Patent Literature 1 (Japanese Laid-Open Publication No. SHO 60-107327) discloses a slotter of FIG. 14, which forms a nick 124 on the cutting blade 111 of the upper slotter knife 110, so that a connecting point 9 is formed between a slotted chip 7 and a flap chip 8, as shown in FIG. 17.

Upon the slotter cutting the corrugated sheet 1, the slotted chip 7 is stuffed into a recess 114, but the presence of the connecting point 9 causes the flap chip 8 to moves below the lower swivel 108 together with the slotted chip 7, so that the flap chip 8 can be correctly treated together with the slotted chip 7.

Then the flap chip 8 together with the slotted chip 7 is completely detached from the corrugated sheet 1 and is removed from the lower swivel 108 by the scraper 120. This configuration solves the above inconvenience. The nick 124 may be formed on a portion of a receiving blade 116 of the recess 114 formed on the lower swivel 108.

### PRIOR ART REFERENCES

### Patent Literature

[Patent Literature 1] Japanese Laid-Open Publication No. SHO 60-107327

### SUMMARY OF INVENTION

### Problems to be Solved by Invention

Since the nick 124 of the slotter of Patent Literature 1 is formed by directly processing the upper slotter knife 110 or the recess 114, the position of the nick 124 is fixed. However, the joint margin 5 has a shape and a size varying with corrugated sheet. The connecting point 9 is required to be outer side from the detaching line c of the joint margin 5, and therefore the position of the connecting point 9 depends on the position of the detaching line c of the joint margin 5.

Accordingly, when a corrugated sheet is small in size, with some shapes and some sizes of joint margins 5, the connecting point 9 cannot be formed. If the connecting point 9 cannot be formed, the above inconvenience is occurred. The absence of a discontiguous portion between the slot 4 and the detaching line c causes the flap chip 8 to separate from the slotted chip 7 and to be scattered around the slotter. The flap chips 8 are scattered and adhered to joint margins after being pasted or to corrugated sheets being under the printing part in the case former to cause problems of inferior gluing of the joint margin or chip intrusion.

For the above, scattering of flap chips has conventionally needed to be mitigated by slowing the travel speed (i.e. the producing speed) of corrugated sheets in the case former.

With the foregoing problems in view, the object of the present invention to surely form a connecting point between a slotted chip and a flap chip which are generated when a slotter of a case former forms a joint margin of a corrugated board and also to prevent the flap chip from scattering, so that inferior gluing of the joint margin and intrusion of the flap chip into the corrugated sheets.

### Means to Solve the Problem

To attain the object, there is provided a method for cutting a corrugated sheet by a slotter that includes: a first swivel and a second swivel that rotate in respective different directions and that are vertically disposed; a slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess, respectively fitted to the inner cutting blade and the outer cutting blade; and a nick formed on at least one of the outer cutting blade of the slotter knife and the outer receiving blade of the recess, the slotter knife and the flap cutter knife removing a corner portion of one end of the corrugated sheet placed between the first swivel and the second swivel such that a resultant slotted chip and a resultant flap chip are connected at a connection, the method comprising: separating a portion having the nick from a main body of the slotter knife or a main body of the second swivel such that a distance along the circumference direction of the first or second swivel between the nick and a tip of the flap cutter knife is adjustable, and disposing the nick in vicinity of the tip of the flap cutter knife.

In the method of the present invention, the first swivel having the slotter knife or the second swivel having the recess to receive the cutting blades of the slotter knife has the portion having the nick and the remaining portion, which are separated from each other, so that the distance along the circumference direction of the first or second swivel between the nick and the tip of the flap cutter knife is adjustable. With this configuration, even when the sizes and the shapes of a corrugated sheet and a joint margin vary, the nick can always be positioned in the vicinity of the tip of the flap cutter knife. Thereby, the connection between the slotter chip and the flap chip can be surely formed regardless of the shapes of the joint margin. Accordingly, flap chips are prevented from scattering, so that the problems of inferior gluing of joint margins and of intrusion of chips into corrugated sheet caused by the flap chips can be solved.

A slotter that the above method can directly adopt includes: a first swivel and a second swivel that rotate in respective different directions and that are vertically disposed; a slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess, respectively fitted to the inner cutting blade and the outer cutting blade; and a nick formed on at least one of the outer cutting blade of the slotter knife and the outer receiving blade of the recess, the slotter knife and the flap cutter knife removing a corner portion of one end of a corrugated sheet placed between the first swivel and the second swivel such that a resultant slotted chip and a resultant flap chip are connected, wherein a portion having the nick is separated from a main body of the slotter knife or a main body of the second swivel, and a distance along the circumference direction of the first or second swivel between the nick and a tip of the flap cutter knife is adjustable.

With this configuration of the slotter, even when the sizes and the shapes of a corrugated sheet and a joint margin vary, the nick can always be positioned in the vicinity of the tip of the flap cutter knife. Thereby, a connection between the slotter chip and the flap chip can be surely formed regardless of the shapes of the joint margin.

The slotter may further include a plurality of the nicks that form a plurality of connections between the slotted chip and the flap chip. When a number of nicks are provided, the slotter chip and the flap chip can be connected at a number of connections, so that the slotter chip can be surely connected to the flap chip. This configuration is effective for a large-size corrugated sheet from which a large-area of a flap chip is to be removed.

The slotter may further include a crimping knife, at the same point in the axis direction of the first swivel as the flap cutter knife is disposed, that crimps the flap chip in the width direction of the flap chip.

This configuration can provide the flap chip to a crimping line, so that the falling flap chip can escape from being caught in narrow potions. Consequently, slotter chips can be surely removed. This is particularly effective for a large-size corrugated sheet from which a large-area of a flap chip is to be removed.

There is provided a slotter knife included in a slotter that includes: a first swivel and a second swivel that rotate in respective different directions and that are vertically disposed; the slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess respectively fitted to the inner cutting blade and the outer cutting blade; and a nick formed on the outer cutting blade of the slotter knife, the slotter knife and the flap cutter knife removing a corner portion of one end of a corrugated sheet placed between the first swivel and the second swivel such that a resultant slotted chip and a resultant flap chip are connected at a connection, wherein a portion having the nick is separated from the main body of the slotter knife, and the portion is attachable to the main body of the slotter knife and has an adjustable distance along the circumference direction of the first swivel from a tip of the flap cutter knife.

The configuration of the slotter knife of the present invention, when the slotter knife is mounted on a slotter, always makes it possible to arrange the nick in the vicinity of the tip of the flap cutter knife even if the sizes and the shapes of a corrugate sheet and a joint margin vary. Thereby, a connection formed between a slotter chip and a flap chip can always be arranged in the vicinity of the joint margin, so that the connection can be surely formed regardless of the shapes of the joint margin.

There are provided a first swivel and a second swivel included in a slotter including: the first swivel and the second swivel that rotates in respective different directions and that are vertically disposed; a slotter knife disposed on the first swivel and having an inner cutting blades and an outer cutting blade on the both sides of the outer circumference; a flap cutter knife disposed on the first swivel perpendicularly to the slotter knife; a recess disposed on the outer circumference of the second swivel and having receiving blades, on the both sides of the recess, each fitted to one of the inner cutting blade and the outer cutting blade; and a nick formed on one of the receiving blades of the recess, the slotter knife and the flap cutter knife removing a corner portion of one end of a corrugated sheet placed between the first swivel and the second swivel such that a resultant slotted chip and a resultant flap chip are connected at a connection, wherein a portion having the nick is separated from the main body of the second swivel, and the portion is attachable to the main body of the second swivel and has an adjustable distance along the circumference direction of the second swivel from a tip of the flap cutter knife.

The configuration of the swivels of the present invention, when the swivels are mounted on a slotter, always makes it possible to arrange the nick in the vicinity of the tip of the flap cutter knife even if the sizes and the shapes of a corrugate sheet and a joint margin vary. Thereby, a connection formed between a slotter chip and a flap chip can always be arranged in the vicinity of the joint margin, so that the connection can be surely formed regardless of the shapes of the joint margin.

### Effect of Invention

According to the method for cutting a corrugated sheet by a slotter, the slotter includes a first swivel and a second swivel that rotate in respective different directions and that are vertically disposed; a slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess, respectively fitted to the inner cutting blades and the outer cutting blade; and a nick formed on at least one of the outer cutting blade of the slotter knife and the outer receiving blade of the recess, the slotter knife and the flap cutter knife removing a corner portion of one end of a corrugated sheet placed between the first swivel and the second swivel such that a resultant slotted chip and a resultant flap chip are connected, wherein a portion having the nick is separated from a main body of the slotter knife or a main body of the second swivel such that distance along the circumference direction between the nick and a tip of the flap cutter knife is adjustable. With this configuration, even when the sizes and the shapes of a corrugated sheet and a joint margin vary, the nick can always be positioned in the vicinity of the tip of the flap cutter knife. Thereby, a connection between the slotter chip and the flap chip can be surely formed regardless of the shapes of the joint margin. Accordingly, flap chips are prevented from scattering, so that inferior gluing of joint margins and intrusion of chips into corrugated sheet caused by the flap chips can be avoided.

The slotter of the present invention includes: a first swivel and a second swivel that rotate in respective different directions and that are vertically disposed; a slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess, respectively fitted to the cutting blades; and a nick formed on at least one of the outer cutting blade of the slotter knife and the outer receiving blade of the recess, the slotter knife and the flap cutter knife removing a corner portion of one end of a corrugated sheet placed between the first swivel and the second swivel such that a resultant slotted chip and a resultant flap chip are connected, wherein a portion having the nick is separated from a main body of the slotter knife or a main body of the second swivel, and a distance along the circumference direction of the first or second swivel between the nick and a tip of the flap cutter knife is adjustable. This configuration of the slotter ensures the same effects as the above method for cutting.

The slotter knife of the present invention is included in a slotter that includes: a first swivel and a second swivel that rotate in respective different directions and that are vertically disposed; the slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess, respectively fitted to the cutting blades; and a nick formed on the outer cutting blade of the slotter knife, the slotter knife and the flap cutter knife removing a corner portion of one end of a corrugated sheet placed between the first swivel and the second swivel such that a resultant slotted chip and a resultant flap chip are connected at a connection, wherein a portion having the nick is separated from the main body of the slotter knife, and the portion is attachable to the main body of the slotter knife and has an adjustable distance along the circumference direction of the first swivel from a tip of the flap cutter knife. This configuration of the slotter knife ensures the same effects as the above method for cutting.

The swivels of the present invention are included in a slotter that includes: the first swivel and the second swivel that rotate

in respective different directions and that are vertically disposed; a slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having receiving blades, on the both sides of the recess, each fitted to one of the cutting blades; and a nick formed on one of the receiving blades of the recess, the slotter knife and the flap cutter knife removing a corner portion of one end of a corrugated sheet placed between the first swivel and the second swivel such that a resultant slotted chip and a resultant flap chip are connected at a connection, wherein a portion having the nick is separated from the main body of the second swivel, and the portion is attachable to the main body of the second swivel and has an adjustable distance along the circumference direction of the second swivel from a tip of the flap cutter knife. This configuration of the swivels ensures the same effects as the above method for cutting.

### BRIEF DESCRIPTION OF DRAWING

FIG. 1 A perspective view of a slotter knife according to a first embodiment of the present invention;

FIG. 2 A side view of a slotter knife of the first embodiment;

FIG. 3 A side view of a slotter knife according to a second embodiment of the present invention;

FIG. 4 A side view of an example of the configuration of a division of a slotter knife of the present invention;

FIG. 5 A side view of another example of the configuration of a division of a slotter knife of the present invention;

FIG. 6 Aside view of an additional example of the configuration of a division of a slotter knife of the present invention;

FIG. 7 A perspective view of a slotter knife according to a third embodiment of the present invention;

FIG. 8 A plane view of a corrugated sheet slotted and crimped with a slotter knife according to a fourth embodiment of the present invention;

FIG. 9 A front view of a slotter knife of the fourth embodiment;

FIG. 10 A perspective view of a swivel of the first embodiment;

FIG. 11 A plane view of a corrugated sheet slotted with a slotter knife;

FIG. 12 A vertical front sectional view of a conventional slotter that slots a corrugated sheet;

FIG. 13 A side view of the slotter of FIG. 12;

FIG. 14 A perspective view of another conventional slotter (Patent Literature 1);

FIG. 15 An enlarged plane view of a joint margin of a corrugated sheet slotted with the slotter of FIG. 12;

FIG. 16 An enlarged plane view of a joint margin of a corrugated sheet otherwise slotted with the slotter of FIG. 12; and

FIG. 17 An enlarged plane view of a joint margin of a corrugated sheet slotted with the slotter of Patent Literature 1.

### EMBODIMENT TO CARRY OUT INVENTION

Hereinafter, the present invention will now be detailed with reference to the accompanying drawings illustrating various embodiments. Dimension, material, shape, and relative position of the components described in embodiments should by no means be limited to those of the description unless specified.

### First Embodiment

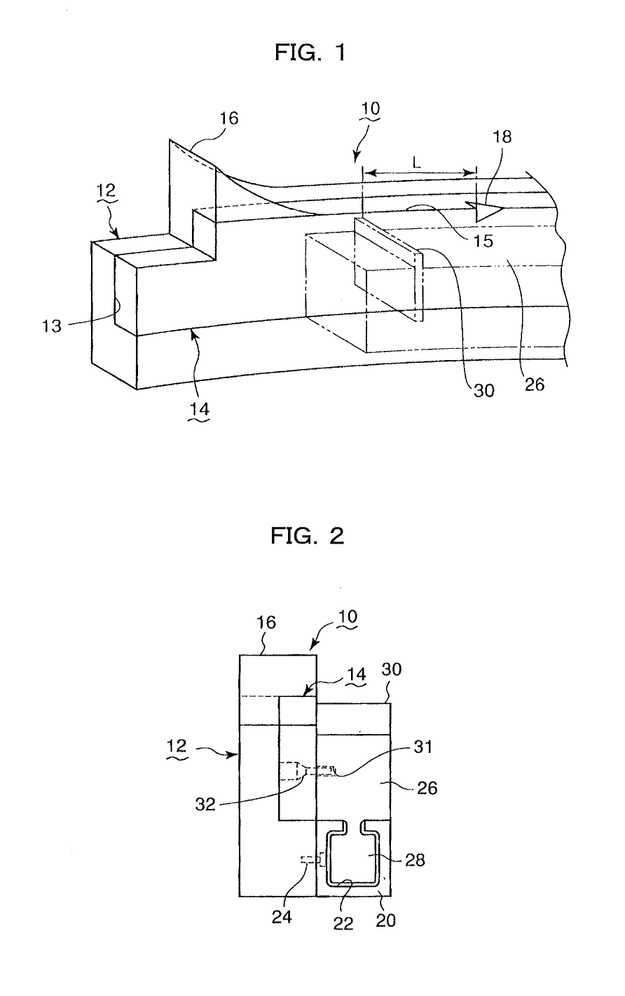

The first embodiment of the present invention will now be described with reference to FIGS. 1 and 2, which illustrate an upper slotter knife 10. The upper slotter knife 10 consists of a slotter knife body 12 and a division 14 separated from the slotter knife body 12. The slotter knife body 12 includes a cut-off knife 16 formed integrally with the slotter knife body 12 and projecting to the exterior. The cut-off knife 16 cuts off the bottom of a slot 4 where the receiving blades 116 of the recess 114 are absent. A cutting blade corrugated sheet 15 of the division 14 has a nick 18.

Referring to FIG. 2, a rail 20 is fixed to a lower portion of a side wall of the slotter knife body 12 via a bolt 24. A rectangular lower support 28 of a sliding member 26 is slidably fitted into a recess 22 of the rail 20. In the top surface of the sliding member 26, a base of a flap cutter knife 30 is embedded which forms a detaching line (i.e., detaching line c in FIG. 15) that detaches the flap chip 8 from the joint margin 5. The division 14 is fixed to a side wall of the sliding member 26 via a bolt 32.

On the sliding member 26, a number of screw holes 31 are arranged in parallel along the sliding direction of the sliding member 26, so that selecting one screw hole 31 determines the fixed position of the division 14 relative to the sliding member 26.

With this configuration, the sliding member 26 and the division 14 are placed in such a position that the distance L between the flap cutter knife 30 and the nick 18 is minimized, and are then coupled via the bolt 32. The division 14 accommodated in the recess 13 having an L-shaped cross section and being included in the slotter knife body 12.

Next, the sliding member 26 is slid along the slotter knife body 12 and is positioned such that a detaching line c to be formed conforms to the sizes and the shapes of a corrugated sheet to be cut and a joint margin. After the positioning, the sliding member 26 is fixed to the slotter knife body 12.

Thereby, a connecting point 9 between the slotted chip 7 and flap chip 8 can be formed in the vicinity of the detaching line c. Advantageously, even if it seems to be difficult to form the connecting point 9 because the flap chip 8 has a small area, the connecting point 9 can be surely formed. Accordingly, with regard to a small-size corrugated sheet and the like, it is possible to prevent the flap chips 8 from scattering, thereby avoiding inadequate gluing of the joint margin 5 and also avoiding intrusion of flap chips 8 into fabricated corrugated sheet 1.

The shape of the nick 18 can be properly selected from various candidates such as a triangular pyramid and a circular concave.

Besides, coupling the sliding member 26 and the division 14 allows the cut-off knife 16 of the slotter knife body 12 and the flap cutter knife 30 to have only a small gap, so that the flap chip 8 is prevented from being left uncut. Since the sliding member 26 in which the flap cutter knife 30 is partially embedded and the division 14 having the nick 18 are integrated, the distance L can be maintained and the gap between the cut-off knife 16 on the slotter knife body 12 and the flap cutter knife 30 can be freely changed.

### Second Embodiment

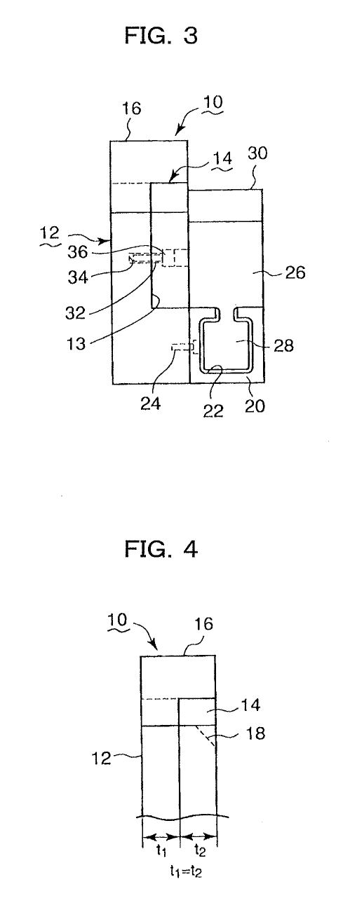

Next, the second embodiment of the present invention will now be described with reference to FIG. 3. As illustrated in FIG. 3, the division 14 is accommodated in the recess 13 of the slotter knife body 12 and is fixed to the slotter knife body 12 via the bolt 36. The division 14 has a long hole 32 having a longer axis along the sliding direction of the sliding member 26. The side wall of the recess 13 which wall is in contact with the long hole 32 has a number of screw holes 34 at appropriate intervals so as to agree with the long hole 32. The identical parts and devices between FIGS. 2 and 3 are represented by the same reference numbers.

With this configuration, the division 14 is positioned relatively to the slotter knife body 12 such that the distance L (see FIG. 1) between the nick 18 formed on the division 14 and the flap cutter knife 30 is minimized. Then, keeping this position, the bolt 36 is inserted into the long hole 32 and is screwed into the screw hole 34. Then, sliding member 26 is positioned relatively to the slotter knife body 12 and is then fixed to the slotter knife body 12.

In this embodiment, since the division 14 is not coupled to the sliding member 26, the distance between the nick 18 and the flap cutter knife 30 can be freely changed. In addition, separation between the division 14 and the sliding member 26 can lighten the weight of the sliding member 26, abating power that a driving device requires to slide the sliding member 26.

Description will now be made in relation of examples of the configuration of the division 14 of the present invention with reference to FIGS. 4-6.

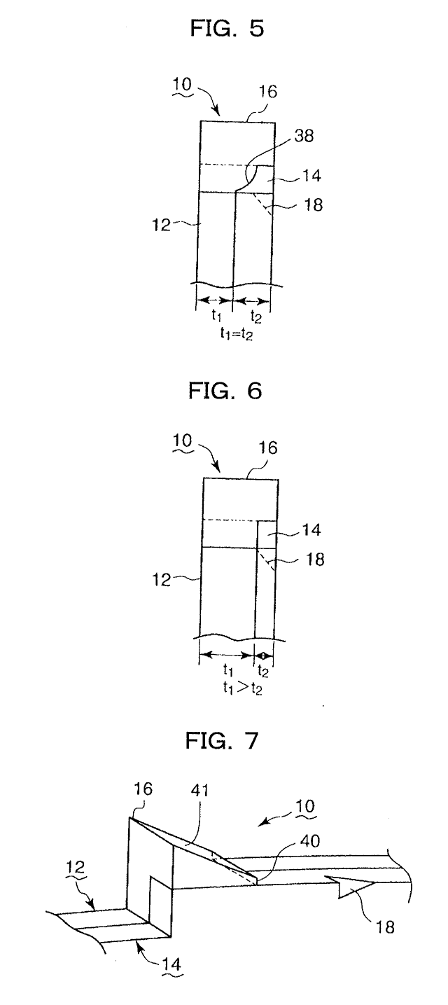

FIG. 4 illustrates the division 14 having a rectangular cross section and having a thickness t₂ the same as the thickness t₁ of the slotter knife body 12. FIG. 5 illustrates the division 14 having an upper corner cut into an arc and having a thickness t₂ same as the thickness t₁ of the slotter knife body 12. An arc-shaped inclination 38 of an upper corner of the division 14 enhances the strength of lower part of the cut-off knife 16 included in the slotter knife body 12.

FIG. 6 illustrates the division 14 having a rectangular cross section the same as that of FIG. 4 but is different from that of FIG. 4 in the point that the thickness t₁ of the slotter knife body 12 is thicker than the thickness t₂ of the division 14. The division 14 of FIG. 6 is the same as that of FIG. 4 except for the thickness.

In this embodiment, the slotter knife body 12, which has a thickness t₁ larger than the thickness t₂ of the division 14, is allowed to have an increased strength of the slotter knife body 12.

### Third Embodiment

Next, the slotter knife of a third embodiment of the present invention will now be described with reference to FIG. 7. The upper slotter knife 10 illustrated in FIG. 7 is different from that of the first embodiment in the points that the base of the cut-off knife 16 of the slotter knife body 12 is formed into a pillar 40 and an inclined face 41 on the pillar 40 is flat. The presence of the pillar 40 and the inclined face 41 on the pillar 40 enhances the strength of the cut-off knife 16 of the third embodiment.

### Fourth Embodiment

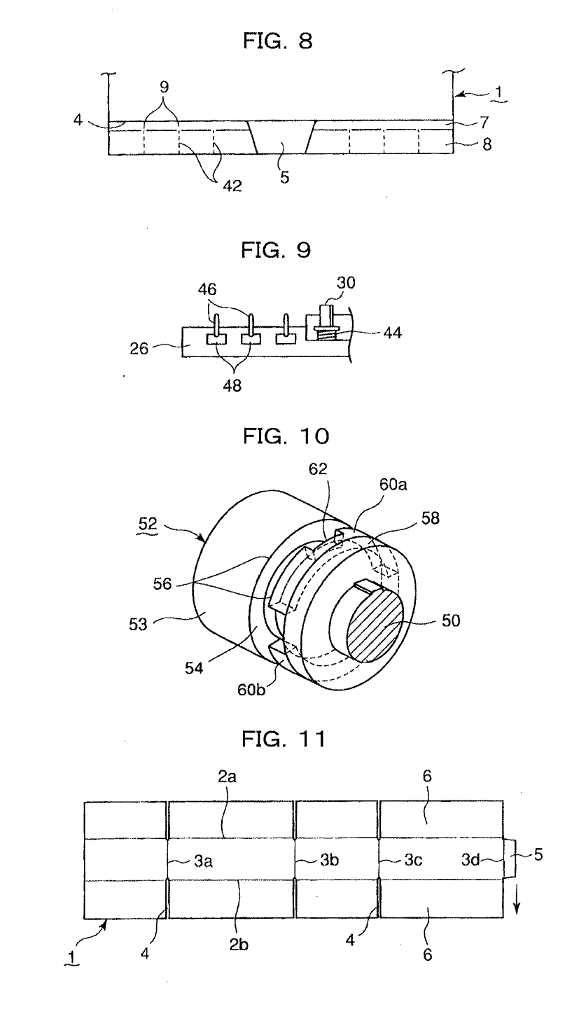

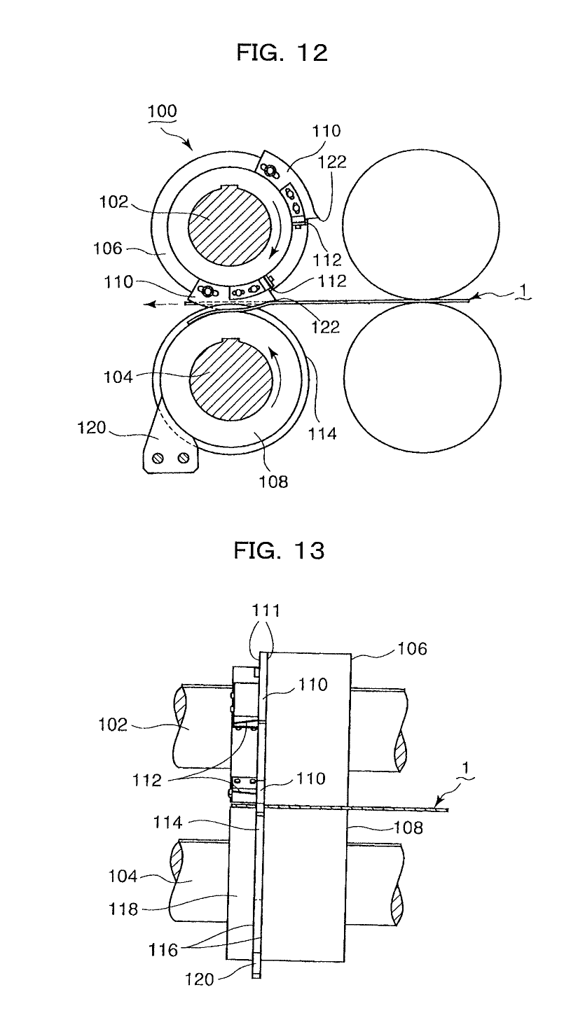

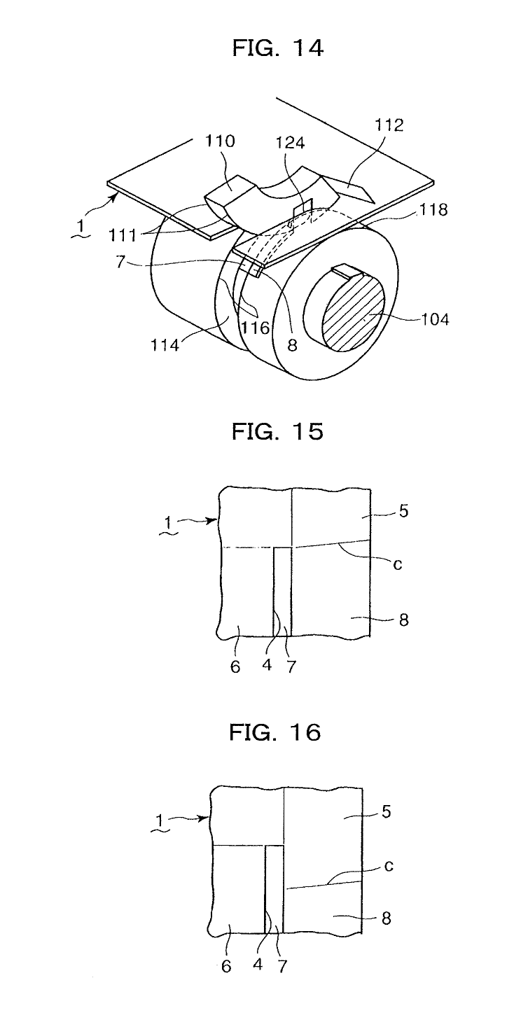

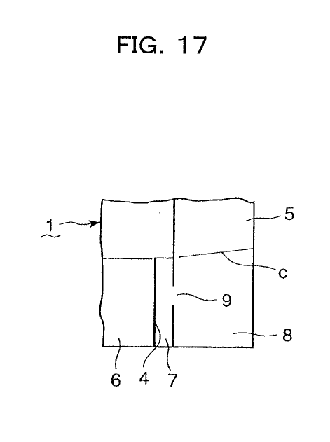

Next, the slotter knife of a fourth embodiment of the present invention will now be described with reference to FIGS. 8 and 9. As shown in FIG. 8, the fourth embodiment concerns a slotter knife that allows the slotted chip 7 and the flap chip 8 to have a number of connection points 9 at which the slotted chip 7 and the flap chip 8 are connected to each other. A number of nicks 18 are formed on the cutting blade 15 of the division 14, so that three connection points 9 are formed on one side of the joint margin 5 as illustrated in the drawing. Additionally, a number of crimping lines 42 are formed on the flap chip 8.

Even when the sizes and shapes of the corrugated sheet 1 and the joint margin 5 vary, the presence of a number of connection points 9 surely connects the slotted chip 7 and the flap chip 8 and more firmly connects the slotted chip 7 and flap chip 8. Thereby, it is possible to prevent the flap chip 8 from separating from the slotted chip 7 and also from scattering.

The crimping lines 42 causes the flap chip 8 to be easily bend at the crimping lines 42, so that the flap chip 8 falls without being caught in narrow portions.

FIG. 9 shows the configuration of an apparatus that provides the crimping lines 42 onto the corrugated sheet 1. In FIG. 9, flap cutter knife 30 is embedded in the sliding member 26. Specifically, the flap cutter knife 30 is installed in the sliding member 26 via a spring 44, which prevents the flap cutter knife 30 from being excessively loaded. In addition, the roots of a number of crimping knives 46 are also embedded in the sliding member 26. The tips of the crimping knives 46 are lower in level of the tip of the flap cutter knife 30, so that the crimping lines 42 are formed on the corrugated sheet 1. Elastic members 48 are embedded in the roots of the respective crimping knives 46, which prevents the crimping knives 46 from being excessively loaded. The crimping knife 46, at the same point in the axis direction of the upper swivel 106 as the flap cutter knife 30 is disposed, crimps the flap chips 8 in the width direction of the flap chips 8.

### Fifth Embodiment

Next, a fifth embodiment of the lower swivel will now be described with reference to FIG. 10. The fifth embodiment forms the nick on the lower swivel. As illustrated in FIG. 10, a lower swivel 52 shaped cylindrically is placed around a rotation axis 50 of the slotter. The lower swivel 52 basically consists of a lower swivel body 53 and divisions 60a and 60b. The lower swivel body 53 has a recess 54 into which the cutting blade can be fitted (not illustrated, cutting blade 111 of FIG. 13. On one of the side walls of the recess 54, two arc-shaped divisions 60a and 60b, which are separated from the lower swivel body 53, are disposed. The divisions 60a and 60b are fixed to the side wall of the recess 54 by means of couplers such as bolts.

The other side wall of the recess 54, one of the side walls of the division 60a, and one of the side walls of the division 60b serve as receiving blades 56 to receive the cutting blade of the slotter knife. The outer circumference 58 of the lower swivel 52 serves as a face that receives the flap cutter knife.

With this configuration, the divisions 60a and 60b are circularly moved inside the recess 54 relatively to each other around the circumference of the lower swivel 52 and are positioned such that a nick 62 comes close to the tip of the flap cutter knife mounted to the upper swivel. Then, the divisions 60a and 60b at the positions determined as the above are fixed to the lower swivel 52 by means of coupler, such as bolts.

Since this configuration can dispose the connecting point 9 formed by the nick 62 in the vicinity of the detaching line C between the flap chip 8 and the joint margin 5, at least one connecting point 9 can be surely formed even when the sizes and the shapes of the corrugated sheet 1 and the joint margin 5 vary. Accordingly, scattering of the flap chips 8 can be avoided, so that inferior gluing of the joint margin 5 and intrusion of flap chips 8 into corrugated sheets can be surly avoided.

### INDUSTRIAL APPLICABILITY

The present invention can avoid scattering of flap chips in a slotter of a case former, and can consequently avoid inferior gluing of the joint margin 5 and intrusion of flap chips 8 into corrugated sheets.

1. A method for cutting a corrugated sheet by a slotter that comprises: a first swivel and a second swivel that rotate in respective different directions and that are vertically disposed; a slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess, respectively fitted to the inner cutting blade and the outer cutting blade; and a nick formed on at least one of the outer cutting blade of the slotter knife and the outer receiving blade of the recess, the slotter knife and the flap cutter knife removing a corner portion of one end of the corrugated sheet placed between the first swivel and the second swivel such that a resultant slotted chip and a resultant flap chip are connected at a connection, the method comprising:
separating a portion having the nick from a main body of the slotter knife or a main body of the second swivel such that a distance along the circumference direction of the first or second swivel between the nick and a tip of the flap cutter knife is adjustable, and
disposing the nick in vicinity of the tip of the flap cutter knife.

2. A slotter comprising:
a first swivel and a second swivel that rotate in respective different directions and that are vertically disposed;
a slotter knife disposed on the first swivel and having an inner cutting blade and an outer cutting blade on the both sides of the outer circumference;
a flap cutter knife disposed on the first swivel perpendicularly to the slotter knife;
a recess disposed on the outer circumference of the second swivel and having an inner receiving blade and an outer receiving blade, on the both side of the recess, respectively fitted to the inner cutting blade and the outer cutting blade; and
a nick formed on at least one of the outer cutting blade of the slotter knife and the outer receiving blade of the recess, the slotter knife and the flap cutter knife removing a corner portion of one end of a corrugated sheet placed between the first swivel and the second swivel such that a resultant slotted chip and a resultant flap chip are connected, wherein
a portion having the nick is separated from a main body of the slotter knife or a main body of the second swivel, and
a distance along the circumference direction of the first or second swivel between the nick and a tip of the flap cutter knife is adjustable.

3. The slotter according to claim 2, further comprising a plurality of the nicks that form a plurality of connections between the slotted chip and the flap chip.

4. The slotter according to claim 2, further comprising a crimping knife, at the same point in the axis direction of the first swivel as the flap cutter knife is disposed, that crimps the flap chip in the width direction of the flap chip.

5. A slotter knife included in a slotter that comprises: a first swivel and a second swivel that rotate in respective different directions and that are vertically disposed; the slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having an inner receiving blade and an outer receiving blade, on the both sides of the recess, respectively fitted to the inner cutting blade and the outer cutting blade; and a nick formed on the outer cutting blade of the slotter knife, the slotter knife and the flap cutter knife removing a corner portion of one end of a corrugated sheet placed between the first swivel and the second swivel such that a resultant slotted chip and a resultant flap chip are connected at a connection, wherein
a portion having the nick is separated from the main body of the slotter knife, and
the portion is attachable to the main body of the slotter knife and has an adjustable distance along the circumference direction of the first swivel from a tip of the flap cutter knife.

6. A first swivel and a second swivel included in a slotter comprising: the first swivel and the second swivel that rotates in respective different directions and that are vertically disposed; a slotter knife disposed on the first swivel and having an inner cutting blade and an outer cutting blade on the both sides of the outer circumference; a flap cutter knife disposed on the first swivel perpendicularly to the slotter knife; a recess disposed on the outer circumference of the second swivel and having receiving blades, on the both sides of the recess, each fitted to one of the inner cutting blade and the outer cutting blade; and a nick formed on one of the receiving blades of the recess, the slotter knife and the flap cutter knife removing a corner portion of one end of a corrugated sheet placed between the first swivel and the second swivel such that a resultant slotted chip and a resultant flap chip are connected at a connection, wherein
a portion having the nick is separated from the main body of the second swivel, and
the portion is attachable to the main body of the second swivel and has an adjustable distance along the circumference direction of the second swivel from a tip of the flap cutter knife.

7. The slotter according to claim 3, further comprising a crimping knife, at the same point in the axis direction of the first swivel as the flap cutter knife is disposed, that crimps the flap chip in the width direction of the flap chip.
